(19) United States
(12) Patent Application Publication
(10) Pub. No.: US 2010/0009242 A1
(43) Pub. Date: Jan. 14, 2010

(54) CARBON NANOWALL WITH CONTROLLED STRUCTURE AND METHOD FOR CONTROLLING CARBON NANOWALL STRUCTURE

(76) Inventors: Masaru Hori, Aichi (JP); Mineo Hiramatsu, Aichi (JP); Hiroyuki Kano, Aichi (JP); Toru Sugiyama, Aichi (JP); Yuichiro Hama, Aichi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/374,844

(22) PCT Filed: Jul. 25, 2007
(86) PCT No.: PCT/JP2007/065036

§ 371 Date: Jan. 23, 2009

(30) Foreign Application Priority Data
Jul. 25, 2006 (JP) 2006-201927

(51) Int. Cl. H01M 4/86; C01B 31/02; B01J 32/00

(52) U.S. Cl. 429/44; 428/141; 427/577; 427/561; 977/755

(57) ABSTRACT

Provided is a method for controlling a carbon nanowall (CNW) structure having improved corrosion resistance against high potential by varying the spacing between the carbon nanowall (CNW) walls so that its surface area and crystallinity are controlled. Also provided is a carbon nanowall (CNW) with a high surface arca and a carbon nanowall (CNW) with a high crystallinity, both of which have a controlled structure. According to the present invention, provided are: (1) a carbon nanowall, characterized by having a wall surface area of 50 cm²/cm²-substrate·μm or more; (2) a carbon nanowall, characterized by having a crystallinity such that the D band half value width in the Raman spectrum measured with an irradiation laser wavelength of 514.5 nm is 85 cm⁻¹ or less: and (3) a carbon nanowall, characterized by having not only a wall surface area of 50 cm²/cm²-substrate·μm or more but also a crystallinity such that the D-band half value width in the Raman spectrum measured with an irradiation laser wavelength of 14.5 nm is 85 cm⁻¹ or less.

### TECHNICAL FIELD

The present invention relates to a method for controlling a carbon nanowall structure, and to a novel carbon nanowall obtainable by this method which has a controlled structure, such as surface area and crystallinity.

### BACKGROUND ART

Known examples of carbonaceous porous materials having a nano-size structure include graphite and amorphous, such as fullerene, carbon nanotubes, carbon nanohorns, and carbon nanoflakes.

Among carbonaceous porous materials having a nano-size structure, carbon nanowalls (CNW) are a two-dimensional carbon nanostructure which typically have a wall-like structure in which the walls rise upwards from the surface of a substrate in a substantially uniform direction. Fullerene (such as C60) is a zero-dimensional carbon nanostructure. Carbon nanotubes can be considered to be a one-dimensional carbon nanostructure. Carbon nanoflakes are an aggregate of planar, two-dimensional, small pieces similar to carbon nanowalls. Like rose petals, the individual small pieces are not connected to each other so that their carbon nanostructure has an inferior directionality with respect to the substrate to that of carbon nanowalls. Thus, carbon nanowalls have a carbon nanostructure with totally different characteristics from fullerene, carbon nanotubes, carbon nanohorns, and carbon nanoflakes.

The present inventors have already disclosed a production method and production apparatus focusing on carbon nanowalls in JP Patent Publication (Kokai) No. 2005-97113A. Specifically, as illustrated in FIG. 7, a source gas 32 containing at least carbon as a constituent element is introduced into a reaction chamber 10. The reaction chamber 10 is provided with a parallel plate capacitively coupled plasma (CCP) generating mechanism 20 which includes a first electrode 22 and a second electrode 24. In this way, electromagnetic waves such as RF waves are irradiated to form a plasma atmosphere 34 in which the source gas 32 has been turned into plasma. On the other hand, in a radical generating chamber 41 provided externally to the reaction chamber 10, a radical source gas 36 containing at least hydrogen is decomposed by RF waves or the like to generate hydrogen radicals 38. The hydrogen radicals 38 are injected into the plasma atmosphere 34, and carbon nanowalls form on the surface of a substrate 15 arranged on the second electrode 24.

### DISCLOSURE OF THE INVENTION

Although the existence of carbon nanowalls (CNW) and several basic production methods thereof are known, a method for controlling a structure so as to produce the optimum shape and physical properties of a carbon nanowall (CNW) according to its use and application has until now been unclear.

Accordingly, it is an object of the present invention to provide a method for controlling a carbon nanowall (CNW) structure having improved corrosion resistance against high potential by varying the spacing between the carbon nanowall walls so that its surface area and crystallinity are controlled, and to provide a carbon nanowall (CNW) with a high surface area and a carbon nanowall (CNW) with a high crystallinity both of which have a controlled structure.

The present inventors discovered that by varying the ratio between the introduction rates of process gases in the carbon nanowall (CNW) production process by plasma CVD, the spacing between the carbon nanowall (CNW) walls can be varied, which allows the structure, such as surface area and crystallinity, of the carbon nanowall to be controlled, thereby arriving at the present invention.

Specifically, first, the present invention is an invention of a carbon nanowall having a controlled structure, such as shape and physical properties, as in the following (1) to (3).

(1) A high-surface-area carbon nanowall having a wall surface area of 50 cm²/cm²-substrate·μm or more. (Here, “wall surface area” is the wall surface area per unit substrate surface area per unit wall height.) For example, when the carbon nanowall is used as an electrode catalyst carrier for a fuel cell, it is preferred to have a larger surface area as the amount of supported catalyst increases. A carbon nanowall having a wall surface area of 50 cm²/cm²-substrate·μm or more is preferable, a carbon nanowall having a wall surface area of 60 cm²/cm²-substrate·μm or more is more preferable, and a carbon nanowall having a wall surface area of 70 cm²/cm²-substrate·μm or more is even more preferable.
(2) A carbon nanowall having a crystallinity such that the D band half value width in the Raman spectrum measured with an irradiation laser wavelength of 514.5 nm is 85 cm⁻¹ or less. For example, when using the carbon nanowall as an electronic material for which emphasis is placed on the magnitude of conductivity, higher crystallinity provides higher conductivity and superior corrosion resistance against high potential. Therefore, a carbon nanowall having a crystallinity such that the D band half value width in the Raman spectrum is 85 cm⁻¹ or less is preferable, a carbon nanowall having a crystallinity such that the D band half value width in the Raman spectrum is 65 cm⁻¹ or less is more preferable, and a carbon nanowall having a crystallinity such that the D band half value width in the Raman spectrum is 50 cm⁻¹ or less is even more preferable.
(3) A carbon nanowall which combines high surface area and high crystallinity, having not only a wall surface area of 50 cm²/cm²-substrate·μm or more but also a crystallinity such that the D-band half value width in the Raman spectrum measured with an irradiation laser wavelength of 514.5 nm is 85 cm⁻¹ or less. This carbon nanowall has an increased amount of supported catalyst because of its large surface area, and has high conductivity and excellent corrosion resistance against high potential because of its high crystallinity, and is thus especially suitable as an electrode catalyst carrier for a fuel cell.

Second, the present invention is an invention of a method for controlling a carbon nanowall structure having a controlled structural shape and physical properties such as surface area and crystallinity, wherein, in a method for producing a carbon nanowall by forming in at least a part of a reaction chamber a plasma atmosphere in which a carbon source gas having at least carbon as a constituent element has been turned into plasma, injecting into the plasma atmosphere hydrogen radicals generated externally to the atmosphere from H₂ gas, and forming a carbon nanowall on a surface of a substrate provided in the reaction chamber by reacting the plasma and the hydrogen radicals, a ratio between introduction rates of the H₂ gas and the carbon source gas as a design factor controls the surface area and/or crystallinity of the produced carbon nanowall.

It is noted that the absolute value of the wall surface area is determined by the ratio between the introduction rates of the H₂ gas and the carbon source gas (H₂ gas introduction rate (mol)/carbon source gas introduction rate (mol)), which is a design factor in the present invention, as well as by the values of other design factors. However, in the present specification, the ratio between the introduction rates is discussed with a substrate temperature of 970° C., chamber internal pressure of 800 mTorr, substrate material made of silicon, and a plasma generating source power of 13.56 MHz and 100 W as such other design factors.

Here, the design factor which is the ratio between the introduction rates of the H₂ gas and the carbon source gas (H₂ gas introduction rate (mol)/carbon source gas introduction rate (mol) can be varied over a broad range according to the shape and physical properties, such as surface area and crystallinity, of the desired carbon nanowall. Generally, although the ratio between the introduction rates of the H₂ gas and the carbon source gas (H₂ gas introduction rate (mol)/carbon source gas introduction rate (mol)) can be varied by up to about 0.5 to 3, practically a carbon nanowall can be formed when this ratio is 1 to 2.5.

Specifically, by setting the ratio between the introduction rates of the H₂ gas and the carbon source gas (H₂ gas introduction rate (mol)/carbon source gas introduction rate (mol)) to 1.8 or less, a carbon nanowall can be formed having a wall surface area of 50 cm²/cm²-substrate·μm or more. By setting the ratio between the introduction rates of the H₂ gas and the carbon source gas (H₂ gas introduction rate (mol)/carbon source gas introduction rate (mol)) to 1.4 or less, a carbon nanowall can be formed having a surface area of 60 cm²/cm²-substrate·μm or more, and by setting the ratio between the introduction rates of the H₂ gas and the carbon source gas (H₂ gas introduction rate (mol)/carbon source gas introduction rate (mol)) to 1.0 or less, a carbon nanowall can be formed having a surface area of 70 cm²/cm²-substrate·μm or more.

Further, by setting the H₂ gas introduction rate at a 2.5 sccm/cm²-parallel plate electrode surface area or more, a carbon nanowall can be formed having a crystallinity such that the D band half value width in the Raman spectrum is 85 cm⁻¹ or less; by setting the H₂ gas introduction rate to a 4.2 sccn/cm²-parallel plate electrode surface area or more, a carbon nanowall can be formed having a crystallinity such that the D band half value width in the Raman spectrum is 65 cm⁻¹ or less, and by setting the H₂ gas introduction rate to 5.8 sccn/cm²-parallel plate electrode surface area or more, a carbon nanowall can be formed having a crystallinity such that the D band half value width in the Raman spectrum is 50 cm⁻¹ or less.

In the present invention, examples of methods for generating the hydrogen radicals from the H₂ gas include irradiating one or more selected from microwaves, UHF waves, VHF waves, and RF waves on the H₂ gas, and causing the H₂ gas to come into contact with a heated catalyst metal.

In the present invention, examples of the starting material for the carbon source gas include compounds having at least carbon and hydrogen as constituent elements and compounds having at least carbon and fluorine as constituent elements.

Third, the present invention is a catalyst layer for a fuel cell, characterized in that a carrier for the catalyst layer is the above-described carbon nanowall having a controlled structure, and that a catalyst component and/or electrolyte component is supported/dispersed on the carrier for the catalyst layer composed of the carbon nanowall. By using a carbon nanowall having both a high surface area and high crystallinity as the electrode catalyst carrier for a fuel cell, such an electrode catalyst carrier has an increased amount of supported catalyst because of the large surface area of the carbon nanowall, and has high conductivity and excellent corrosion resistance against high potential because of the high crystallinity of the carbon nanowall, and is thus especially suitable as an electrode catalyst carrier for a fuel cell.

By varying the ratio between the introduction rates of the process gases in a carbon nanowall (CNW) production process by plasma CVD, the spacing between the carbon nanowall (CNW) walls can be varied, which allows the surface area and crystallinity to be controlled. The carbon nanowall according to the present invention has an increased amount of supported catalyst because of its large surface area, as well as high conductivity and excellent corrosion resistance against high potential because of its high crystallinity, and is thus especially suitable as an electrode catalyst carrier for a fuel cell.

### BRIEF DESCRIPTION OF THE DRAWINGS

FIG. 1 illustrates a schematic view of one example of an apparatus for forming a carbon nanowall having a controlled structure according to the present invention.

FIG. 2 illustrates a schematic view of an apparatus for forming the carbon nanowall used in the examples.

FIG. 3 illustrates the relationship between the ratio between the introduction rates of the hydrogen gas (H₂) and the carbon source gas (C₂F₆) and the wall surface area of the grown carbon nanowall.

FIG. 4 shows a surface SEM photographic image of a carbon nanowall when H₂ introduction rate/C₂F₆ introduction rate=2.

FIG. 5 shows a surface SEM photographic image of a carbon nanowall when H₂ introduction rate/C₂F₆ introduction rate=1.

FIG. 6 illustrates the relationship between the hydrogen gas (H₂) introduction rate and the crystallinity of the carbon nanowall as determined from Raman spectroscopy.

FIG. 7 illustrates one example of a carbon nanowall control apparatus.

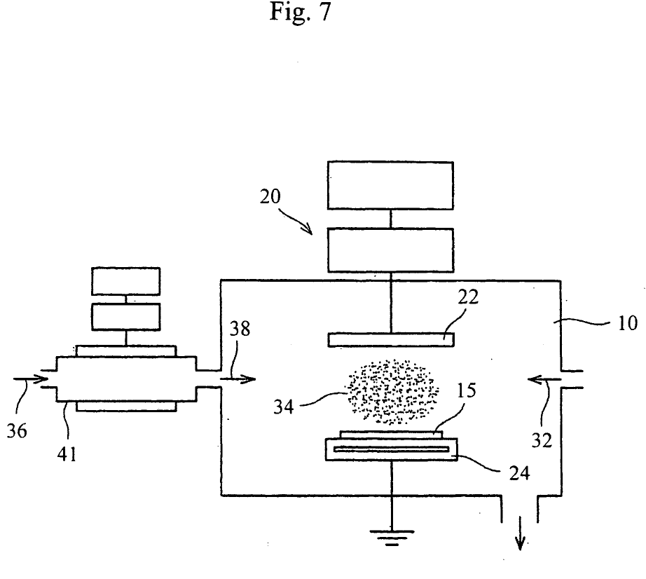

The reference numerals in the drawings are as follows:
1 Plasma CVD apparatus
2 Silicon (Si substrate
3 Heater inside the chamber
4 Plate electrode parallel to the substrate 2
5 Carbon source gas inlet tube
6 hydrogen gas (H₂) inlet tube
7 Plasma generating source
8 Inductive plasma generating source
9 High frequency power apparatus
10 Reaction chamber
15 Carbon source gas inlet tube
20 Plasma discharge means
22 First electrode
24 Second electrode
32 Source gas (raw material)
34 Plasma atmosphere
36 Radical source gas (radical source material)
38 Radical
41 Radical generating chamber

### BEST MODE FOR CARRYING OUT THE INVENTION

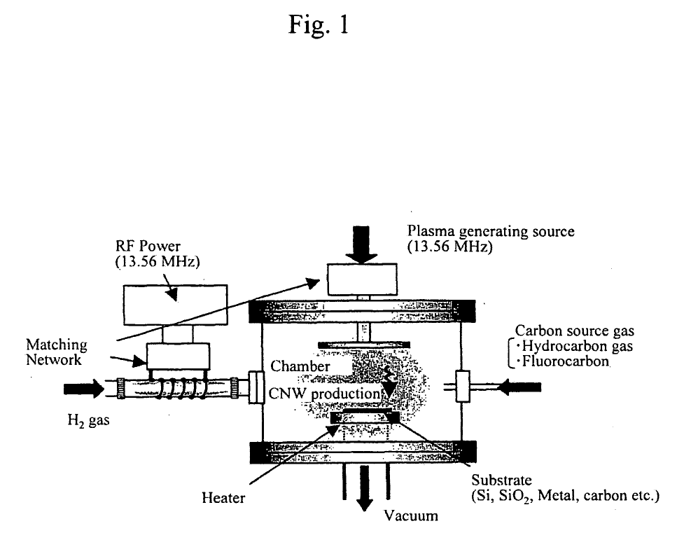

FIG. 1 illustrates a schematic view of one example of an apparatus for forming a carbon nanowall having a controlled structure according to the present invention. Hydrogen radicals as well as a reaction gas (carbon source gas) containing carbon, such as CF₄, C₂F₆, or CH₄, are introduced between parallel plate electrodes in the chamber illustrated in FIG. 1. A carbon nanowall is then formed by PECVD (plasma enhanced chemical vapor deposition). At this stage, the substrate may be heated to approximately 500° C. or more. The distance between the parallel plate electrodes is about 5 cm. Between the plate electrodes, a capacitively coupled plasma is generated using a 13.56 MHz high frequency power apparatus with a power of 100 W. The hydrogen radical generation site is a quartz tube with a length of 200 mm and an internal diameter [φ] of 26 mm. H₂ gas is introduced into the quartz tube to produce an inductively coupled plasma using a 13.56 MHz high frequency power apparatus with a power of 400 W. The flow rate of the carbon source gas and the H₂ gas may be appropriately varied. The chamber internal pressure is, for example, 100 mTrorr. However, this apparatus is merely one example, and the above description is not to be taken as limiting the experimental conditions, equipment, or the results.

### Example 1

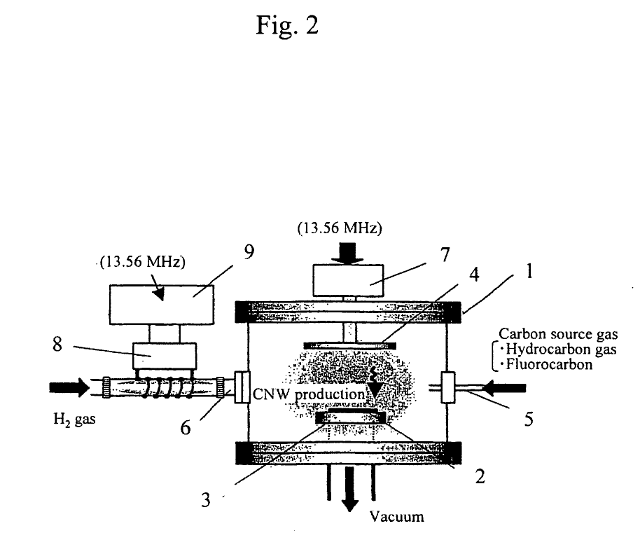

Using the plasma CVD apparatus 1 illustrated in FIG. 2, a substrate 2 formed by silicon (Si) was placed on a heater 3 inside the chamber. The carbon source gas (C₂F₆) was introduced from an inlet tube 5 and hydrogen gas (H₂) was introduced from a separate inlet tube 6 between a plate electrode 4 and the substrate 2 which are parallel to each other. At this stage, the temperature of the heater was set to 970° C.

Capacitively coupled plasma was generated between the plate electrode 4 and the substrate 2 with the distance between the plate electrode 4 and the substrate 2 set to 5 cm and the output power of the plasma generating source 7 set at 13.56 MHz and 100 W. Further, inductively coupled plasma was generated in the inlet tube 6 by an inductive plasma generating source 8. The power of the high frequency power apparatus 9 at this stage was 13.56 MHz and 400 W. The surface area of the parallel plate electrode was 19.625 cm² (φ50).

A CNW was grown on the substrate 2 by a plasma CVD method under the above conditions. The growing was carried out with a carbon source gas flow rate of 50 seem, and a hydrogen gas flow rate divided into 4 levels of 50 (H₂ gas introduction rate (mol)/carbon source gas introduction rate (mol)=1), 70 (H₂ gas introduction rate (mol)/carbon source gas introduction rate (mol)=1.4), 100 (H₂ gas introduction rate (mol)/carbon source gas introduction rate (mol)=2), and 125 sccm (H₂ gas introduction rate (mol)/carbon source gas introduction rate (mol)=2.5).

At this stage, the pressure in the chamber was set to 800 mTorr. Carbon nanowalls grown for 30 minutes in this system had a height of about 300 to 750 nm, and a wall thickness of 10 to 50 nm.

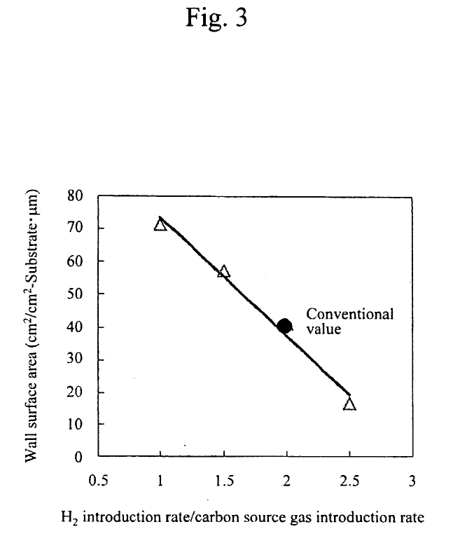

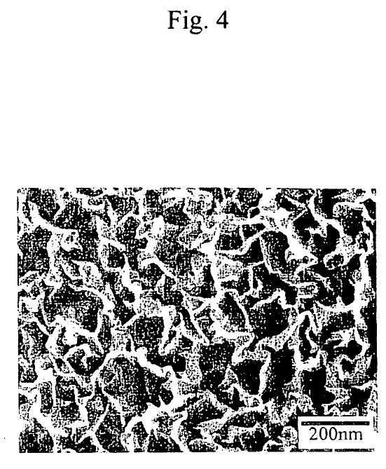

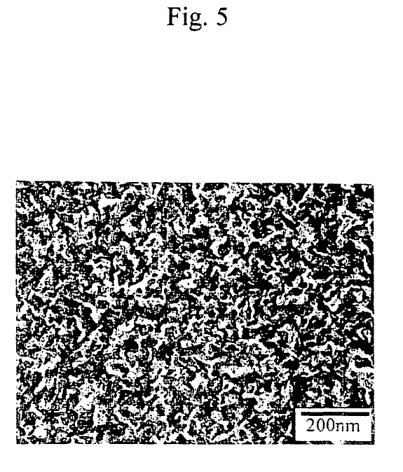

FIG. 3 illustrates the relationship between the ratio between the introduction rates of the hydrogen gas (H₂) and the carbon source gas (C₂F₆) and the wall surface area of the grown carbon nanowall. FIG. 4 shows a surface SEM photographic image of a carbon nanowall when H₂ introduction rate/C₂F₆ introduction rate=2. FIG. 5 shows a surface SEM photographic image of a carbon nanowall when H₂ introduction rate/C₂F₆ introduction rate=1.

From the results of FIGS. 3 to 5, it can be seen that as the ratio between the introduction rates of the hydrogen gas and the carbon source gas (H₂ gas introduction rate (mol)/carbon source gas introduction rate (mol)) decreases, wall spacing is decreased and surface area is increased.

### Example 2

The fact that crystallinity could also be independently controlled was verified using the same CVD process as that of Example 1 while varying the introduction rate of H₂ gas.

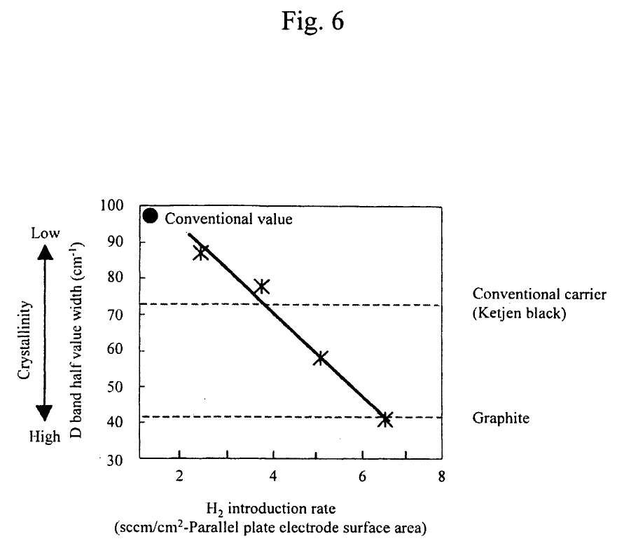

FIG. 6 illustrates the relationship between the hydrogen gas (H₂) introduction rate and the crystallinity of the carbon nanowall as determined from Raman spectroscopy. The degree of crystallinity was approximated by using as an index the D band half value width in the Raman spectrum measured with an irradiation laser wavelength of 514.5 nm. Crystallinity increases as D band half value width decreases. Specifically, by decreasing the H₂ introduction rate, the crystallinity of the carbon nanowall can be increased. In FIG. 6, for reference the D band half value width of the conventional carrier Ketjen black and the D band half value width of graphite were also added. It can be seen that even a carbon nanowall can be made to have a high crystallinity equal to or higher than that of Ketjen black.

### INDUSTRIAL APPLICABILITY

The carbon nanowall according to the present invention has an increased amount of supported catalyst because of its large surface area, and has high conductivity and excellent corrosion resistance against high potential because of its high crystallinity. This carbon nanowall is thus especially suitable as an electrode catalyst carrier for a fuel cell. Accordingly, this carbon nanowall will contribute to the practical use and spread of fuel cells.

1. A carbon nanowall, having a wall surface area of 50 cm²/cm²-substrate·μm or more.

2. A carbon nanowall, having a crystallinity such that the D band half value width in the Raman spectrum measured with an irradiation laser wavelength of 514.5 nm is 85 cm⁻¹ or less.

3. A carbon nanowall, having a wall surface area of 50 cm²/cm²-substrate·μm or more and a crystallinity such that the D-band half value width in the Raman spectrum measured with an irradiation laser wavelength of 514.5 nm is 85 cm⁻¹ or less.

4. A method for controlling a carbon nanowall structure, comprising a method for producing a carbon nanowall by forming in at least a part of a reaction chamber a plasma atmosphere in which a carbon source gas having at least carbon as a constituent element has been turned into plasma, injecting into the plasma atmosphere hydrogen radicals generated externally to the atmosphere from H₂ gas, and forming a carbon nanowall on a surface of a substrate provided in the reaction chamber by reacting the plasma and the hydrogen radicals, a ratio between introduction rates of the H₂ gas and the carbon source gas as a design factor controls the surface area and/or crystallinity of the produced carbon nanowall.

5. The method for controlling a carbon nanowall structure according to claim 4, wherein a ratio between the introduction rates of the H₂ gas and the carbon source gas (H₂ gas introduction rate (mol)/carbon source gas introduction rate (mol)) is 1 to 2.5.

6. The method for controlling a carbon nanowall structure according to claim 4, comprising generating the hydrogen radicals from the H₂ gas by irradiating one or more selected from microwaves, UHF waves, VHF waves, and RF waves on the H₂ gas, and/or causing the H₂ gas to come into contact with a heated catalyst metal.

7. The method for controlling a carbon nanowall structure according to claim 4, wherein the carbon source gas has at least carbon and hydrogen as constituent elements.

8. The method for controlling carbon nanowall structure according to claim 4, wherein the carbon source gas has at least carbon and fluorine as constituent elements.

9. A catalyst layer for a fuel cell, wherein a carrier for the catalyst layer is the carbon nanowall according to claim 1, and wherein a catalyst component and/or electrolyte component is supported/dispersed on the carrier for the catalyst layer composed of the carbon nanowall.
